(19) United States
(12) Patent Application Publication
(10) Pub. No.: US 2007/0145739 A1
(43) Pub. Date: Jun. 28, 2007

(54) Tubing system

(75) Inventor: Johann Haberl, Skarholmen (SE)

Correspondence Address: BROWDY AND NEIMARK, P.L.L.C.;624 NINTH STREET, NW, SUITE 300, WASHINGTON, DC, 20001-5303, US

(73) Assignee: Johann HARBERL, Skarholmen (SE)

(21) Appl. No.: 11/644,842

(22) Filed: Dec. 26, 2006

(30) Foreign Application Priority Data
Dec. 23, 2005 (SE) 0502897-2

(51) Int. Cl. F16L 33/00

(52) U.S. Cl. 285/253

(57) ABSTRACT

A tubing system composed of tube parts and connecting elements forming a flow-through channel. The tube parts are of low elasticity material and the connecting elements are of high elasticity material. At least one connecting element is shaped for changing the speed and/or the direction of movement of a product flowing through the connecting element, wherein at least two of the tube parts of low elasticity material are connected together with a connecting element.

### BACKGROUND OF THE INVENTION

This invention relates to a tubing system and components therefor. The system comprises as components tube parts and connecting elements for connecting tube parts together. The invention also relates to the use of this tubing system

### BRIEF SUMMARY OF THE INVENTION

In a tubing system according to the invention, the tube parts are of low elasticity material and one or more of the connecting elements are of high elasticity material. The connecting elements may also be referred to as jointing elements. The system may of course also comprise other components, such as connecting elements of low elasticity material, e.g., tube bends and branch pipes.

Tubing systems of the type to which this invention relates are to a substantial extent used for transporting fluid or particle materials with a stream of air driven by a subatmospheric pressure or vacuum source. Low air speed values and/or excessively high dust density often cause troublesome blockages in the tubing system. If the air speed is too high, and with a high dust load, wear can occur especially at tube bends and branch pipes. Thus, a balanced speed in hoses and tubes is desired.

The invention is also intended to reduce vibrations and noise. When the tubing system is attached to a building, the noise caused by turbulent flow (e.g., particles bounce against the tube walls) when using conventional tubing systems can be transferred to the frame of the building. The noise may be very disturbing, especially in sensitive industrial environments. It is also desired that the tubing components are suspended in a fireproof way so that the tubing components as far as possible remain in the suspension means in the event of a fire.

The tubing system according to the invention is preferably arranged for and used for carrying a flowing medium comprising gas and/or liquid as a continuous homogenous or nonhomogenous phase and optionally liquid and/or solid phase as a discontinuous phase, transported or carried by the continuous phase. This medium is below also designated herein as a fluid.

An embodiment of the invention comprises a system for transporting solid particle material as a transported, or entrained, phase and gas, especially air, as a transporting, or entraining, phase, and preferably by using a subatmospheric pressure, e.g., provided with a fan or pump, e.g., a turbo pump, as the entraining source.

An embodiment of the invention comprises a system arranged completely or partly in a building and completely or partly carried by supporting means connected to the floor, roof and/or walls of the building.

The system preferably comprises connecting elements of high elasticity material which are provided with a flow-through channel that can cause a change of the direction and/or speed of the fluid stream, e.g., consisting of a conical member, 45° or 90° tube bend, and a branch pipe for connecting three or more tubes together, and/or with a cross-section area that increases and/or decreases in the longitudinal direction, also referred to as the flow-through direction, of the flow-through channel, such as within the entirety, or part, or parts of the longitudinal extent of the flow-through channel, viewed in the longitudinal direction, the cross-section area gradually increasing, or decreasing, or gradually increasing and then decreasing, or gradually decreasing and then increasing in the flow direction.

The low elasticity material forming tube parts may consist of metal, especially iron, copper, aluminum or alloys of one or more of these materials, e.g., stainless or non-stainless steel, or low-alloyed steel, or carbon steel, or non-reinforced or reinforced, especially hard, plastics, e.g., polyesters, polyethylene, polypropylene, polyvinylchloride, etc. As examples of reinforcing materials fiberglass, carbon fibers or other strengthening materials may be mentioned. The low elasticity material may e.g., have a Young's Modulus value of at least 500, or at least 1000, or at least 10,000, or at least 20,000 MPa.

The high elasticity material may consist of elastic materials, such as natural rubber, synthetic rubber, e.g., nitrile rubber, polyurethane or other synthetic materials with similar elasticity. The elasticity of the high elasticity material may, e.g., have a Young's Modulus value equal to or less than 100, or 50, or 25 MPa.

According to one embodiment of the invention, at least one connecting element is supported elastically with the aid of a sleeve of high elasticity material, which encloses at least a part of the connecting element and preferably also a part of at least one tube of low elasticity material connected to the connecting element. The high elasticity material of the sleeve may be the same as or different from the material of the connecting element. The sleeve is preferably surrounded by a compressing element that presses the sleeve against the connecting element and optionally against a tube connected to the connecting element. The compressing element may form, or be a part of, a supporting means that supports at least a part of the weight of the connecting element and optionally a tube or tubes connected or joined to the supporting means, e.g., by the supporting means being connected in a force transmitting manner to a building. According to one embodiment, the supporting means are connected to the compressing element without any metallic contact, e.g., with an intermediate part of plastic or elastomer material.

The use of connecting elements of high elasticity material offers advantages, e.g., since this material can absorb noise and vibrations caused by the material flow in the system, especially by a flow of solid material in the system. Dampening of sound and vibrations and the transfer thereof to supporting means for the system and to objects to which the supporting means are connected, e.g., to walls, roof and floor in a building, may be improved further with the mentioned sleeves of high elasticity material which are arranged between compressing means, or a sheet sleeve, and a connecting element, or tube part, and with means that counteract direct contact between sheet sleeve, screw joint and supporting means, e.g., by arranging a non-metallic sleeve enclosing a screw joint arranged for compressing the compressing means, or a part thereof.

According to one embodiment, at least one of the connecting elements is provided with at least one secondary opening, preferably in the side wall of the connecting element, and extending through the side wall into-the flow-through channel of said element. The secondary opening may be shaped as a secondary inlet opening, especially with cut-off, or blocking, means, e.g., a valve, which permits the introduction of a fluid, especially air, into the system. The valve may be arranged for introducing a fluid into the system by the action of a pressure difference between the system and the surroundings, such as by introducing air at atmospheric pressure from the surroundings to a subatmospheric pressure in the system, especially at one or more locations between a low pressure source at one end of the system and one or more main inlets at one or more other ends of the system, such as when transporting solid material with a gas, e.g., air, through the system

The valve may be arranged to open automatically in response to a certain opening pressure difference or pressure drop across the valve. The opening pressure difference may be adjustable, manually or automatically, e.g., controlled by the conditions, especially the pressure, in various parts of the system. The valve or valves at one or more locations may be arranged, by pre-setting or monitoring, to open for a predetermined period of time and/or at predetermined time intervals.

Operation of the valves may be achieved, e.g., with solenoid valve means, servo-motors or bellows or cylinders actuated by gas or liquid pressure, which exert a thrust or traction force for opening or closing the valve. The valve preferably comprises a spring means, which urges some type of valve closing element, e.g., a cone, stop-cock plug, ball, disc, washer, sealingly against a valve seat that provides an opening for the flow-through of a fluid when the valve is open. By introducing a fluid into the system in this way, it is possible to counteract, e.g., accumulation of solid material at locations that show a tendency to clogging, e.g., tube bends and branch pipes.

When there is clogging at a location in the system, with a resulting reduction in the pressure in the following downstream sections of the system, i.e. closer to the low-pressure source, this pressure reduction may be used for opening a valve at a location upstream from the location of the clogging for increasing the flow of air and increasing the pressure drop at the clogged location. A number of such valves may be connected so that the opening of, and the pressure change at, one valve controls one or more other valves. This may be achieved, e.g., in that the pressure in a bellows at one valve is controlled by the pressure at a downstream location of the system, e.g., at the closest downstream located valve. This control may be achieved, e.g., with a fluid conduit and/or an air hose that provides a liquid or gas communicating connection between the bellows and the locations of the other valves. The connection may also be used for monitoring and forced control by, e.g., electric control, connected to an electronic control system. Monitoring and control of the system may however in particular be achieved by electric means with electric, electromechanical, or electromagnetic servo means, which suitably are connected to a computer.

According to one embodiment of the invention, the system comprises at least one connecting element composed of a tube bend or a branch pipe of high elasticity material, which is provided with at least one secondary opening in the side wall of said element. The secondary opening may extend through the side wall of the connecting element to the flow-through channel of said element and preferably has a substantially smaller opening area than the flow-through channel. Especially, the ratio of the cross-sectional area of the secondary opening to that of the flow-through channel may be equal to or less than 1:5, or 1:10, or 1:30, and especially at least 1:100, or at least 1:50. The secondary opening may be used for connecting monitoring means, e.g., a pressure gauge, flow meter, inlet valve, or inspection window glass, especially with an additional secondary opening. For example, the monitoring means may be an inspection window glass opening in the opposite side wall of the connecting element.

One embodiment of the invention comprises a system for the transport of solid particle materials as the transported phase and gas, especially air, as the transporting phase, especially with a sub-atmospheric pressure providing the conveying force, e.g., achieved with a fan or turbopump as a low-pressure source. Such a transport of particles causes wear especially in tube bends and branch pipes. This invention also comprises tube bends and branch pipes with flow-through channels that in their cross section are of a non-circular shape, i.e. the cross section deviates from a circular shape over at least part of the longitudinal extent of the channel. At least at one location where the centrifugal force is highest and/or at the part of the wall of said element that is situated further away from the center of curvature of the flow-through channel, or the center line, a cross section area of mainly circular shape may thereby be tangentially changed by a bulge deviating from the circular shape or a wing that deflects and distributes the air mixture and/or the particle flow to a larger area or part of the cross section area and influences the distribution of the flow so that a reduced wear may be achieved. In the case of transport of a fluid containing particles with a tendency to adhere, the change of the distribution of the flow may also give reduced adherence to pipe walls, especially in branch pipes and tube bends.

The invention is disclosed in more detail below with reference to the drawings and the examples, which are not intended to restrict the scope of the invention.

### BRIEF DESCRIPTION OF THE DRAWINGS

FIG. 1 is a perspective pictorial view of a part of a tubing system according to one embodiment of the invention.

FIG. 2a is a cross sectional detail view through a junction between two of the components of the tubing system of FIG. 1.

FIG. 2b is a cross sectional detail view of a part of the junction shown in FIG. 2a.

FIG. 2c is a detail view of a portion of the junction of FIG. 2a, in a plane perpendicular to that of FIG. 2a.

FIG. 2d is a cross sectional view of a connecting element at the junction shown in FIG. 2a.

FIG. 3a is a side elevational view of one embodiment of a connecting element according to the invention.

FIG. 3b is a cross sectional view along a plane A-A of FIG. 3a.

FIG. 3c is a cross sectional view through a lower part of the element of FIG. 3a.

FIG. 3d is a cross sectional view along a plane B-b of FIG. 3a.

FIG. 4a is a side elevational view of another embodiment of a connecting element according to the invention.

FIG. 4b is a cross sectional view along a plane A-A of FIG. 4a.

FIG. 4c is a cross sectional view similar to that of FIG. 4b of a modified version of the connecting element of FIG. 4a.

FIG. 4d is a cross sectional view similar to that of FIG. 4b of another modified version of the connecting element of FIG. 4a.

FIGS. 4e and 4f are detail views of alternative forms of a part of the connecting element of FIG. 4a, viewed in a direction parallel to the plane FIG. 4a.

FIG. 4g is a cross sectional detail view of a portion of the connecting element of FIG. 4a in a plane perpendicular to that of FIG. 4a.

FIGS. 4h, i, j and k are cross sectional detail views of components that may be assembled to the connecting element portion of FIG. 4g.

FIG. 4 are cross sectional detail views of alternate forms of construction of the connecting element portion shown in FIG. 4g.

FIG. 5 is an elevational view of a second embodiment of a tubing system according to the invention.

### DETAILED DESCRIPTION OF THE INVENTION

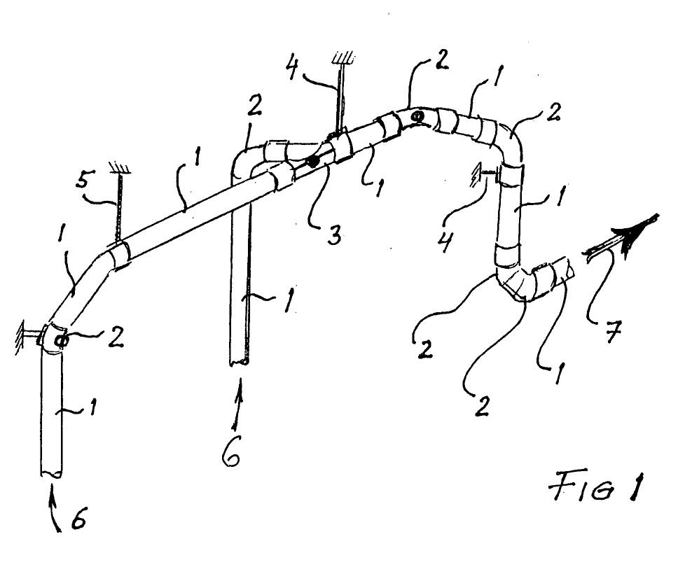

FIG. 1 shows an example of a part of a tubing system according to the invention. The system comprises a number of tube parts 1 of low elasticity material each having an essentially straight shape in the longitudinal direction. The tube parts are joined together by connecting elements of high elasticity material comprising tube bends 2 and branch pipes 3. The tubing system is supported by supporting means 4, which are connected to and hold at least one of the connecting elements and tube parts at the point of connection to the connecting element. FIG. 1 also shows a supporting means 5, which is connected to and holds only one tube part. The supporting means are themselves held by parts of a building (not shown) in which the system is installed. The inlet directions of fluid flowing in the system are indicated by arrows 6 and the outlet direction by arrow 7.

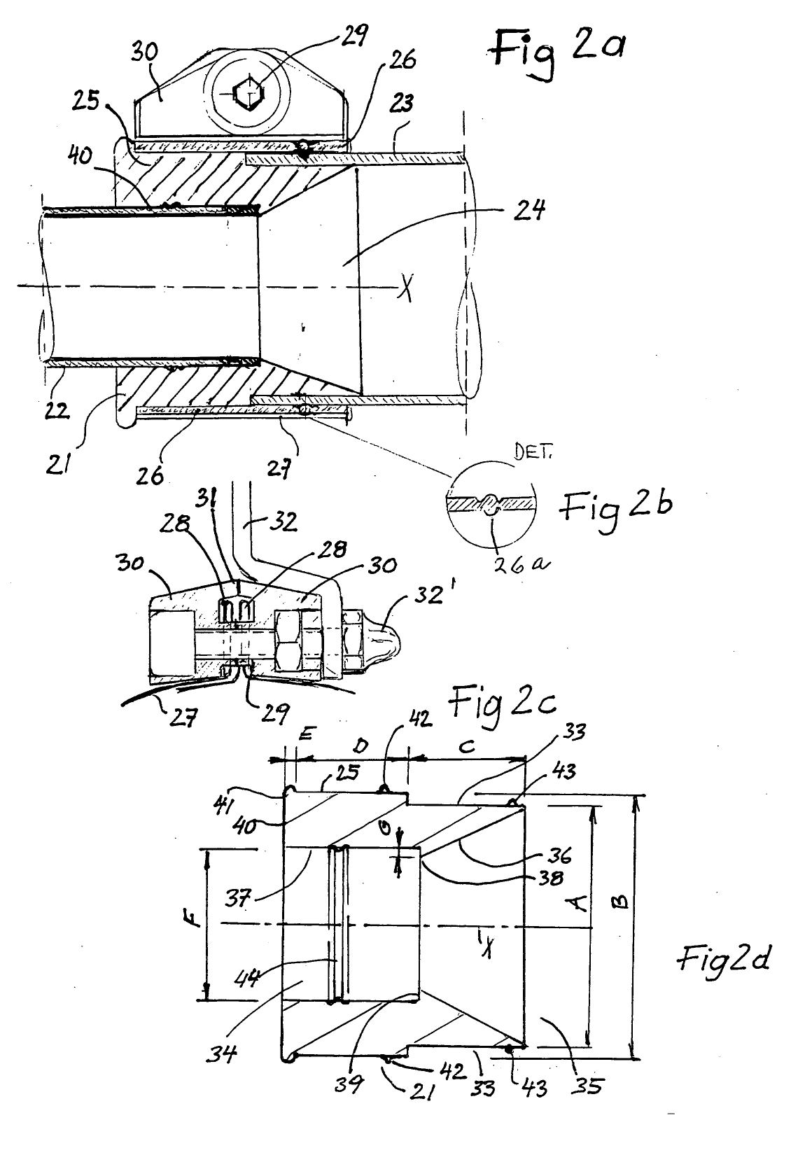

FIG. 2a shows a cross section through connection point between two tube parts 1 having different diameters, FIG. 2b is a cross sectional detail view through a sealing sleeve at the connection point, FIG. 2c is a cross sectional detail view through compressing and supporting means for the connection point, and FIG. 2d is a cross sectional view of the connecting element 21. A low elasticity tube part 22 of smaller cross section extends a certain distance into an end part of a low elasticity tube part 23 of larger cross section, which prevents, e.g., the tube parts from falling if there is a fire in the building.

Connecting element 21, which can also be referred to as an expansion part or conical part, of high elasticity material, is arranged to connect the two tube parts 22, 23 having different diameters and to form a funnel-shaped transition 24 in the flow path between these tube parts.

Connecting element 21 is shaped as a body, or cylinder, of revolution around a longitudinal center axis X and comprises a circular-cylindrical outer part 25 with essentially the same outside diameter as tube part 23 of larger diameter, and an adjacent circular-cylindrical outer part 33 with a diameter that essentially coincides with the inside diameter of tube part 23. Outer part 25 and the end part of tube part 23 that is connected to element 21 are surrounded by a sleeve 26 of high elasticity material, which extends around an end part of tube part 23, which preferably has essentially the same length extent as outer part 25. Sleeve 26 is shaped to be connected in a gas and/or liquid sealing manner and to grip outer part 25 and the end part of tube part 23. Sleeve 26 is surrounded by a compressing part 27, preferably in the shape of a sheet sleeve with essentially the same or slightly smaller longitudinal extent than sleeve 26. The free ends of sleeve 26 are preferably shaped as two flanges 28 that may be pressed together by a suitable clamping arrangement. As shown in FIG. 2c, this clamping arrangement may be a screw joint comprising one or more through bolts 29 that cooperate with mating nuts to urge sleeve 26 against outer part 25 and the end of tube part 23 for securing tube part 23 to connecting element 21.

Simultaneously, elastic connecting element 21 exerts a compressing force against the end part of smaller diameter tube part 22, which has been inserted into a circular-cylindrical bore 40 that has essentially the same inner diameter as the outer diameter the end part of tube part 22. Bore 40 and the end part of tube part 22 are located at the end of connecting element 21 that is remote from funnel-shaped transition 24. Tube part 22 may be inserted with a tight fit or press fit into bore 40.

Flanges 28 are formed by bending sheet sleeve 26 at the ends thereof and are provided with openings for the bolted joint, especially the bolt or bolts 29. The or each bolt 29 extends through two spacers 30 on each side of flanges 28. Spacers 30 transfer the compressing force of the bolt(s) to flanges 28 and extend suitably along at least 75% of or the entire longitudinal extent, parallel to axis X, of the flanges, and especially up over the entire vertical height of the flanges so that the upper ends of spacers 30, which are remote from the connecting element 21 can make a close fit to each other. Furthermore, the spacers 30 may comprise protruding tube shaped parts that enclose a part of the shank of bolt 29 and fit into the bolt openings in the flanges 28, as shown in FIG. 2c, so that the tube shaped parts of spacers 30 are guided into the flange openings. In addition, a direct contact between the bolt(s) 29 and flanges 28 is prevented by the presence of the tube shaped parts and a transfer of noise and vibrations from the tubing through sheet sleeve 26 and through the clamping arrangement to the supporting means can be minimized by suitable selection of the material of spacers 30.

FIG. 2b shows a partial section through the sleeve 26 at a location where the sleeve is provided with a ridge or bead shaped protrusion 26a that extends annularly around the sleeve. Sleeve 26 is suitably provided with a number of such protrusions distributed along the longitudinal extent thereof, and especially at the ends thereof, and protruding radially inwardly and/or radially outwardly. Such protrusions may be distributed along the longitudinal dimension protruding alternatingly radially inwardly and radially outwardly. The radial height of the protrusions is suitably at least 0.2 mm, or at least 0.5 mm, and, e.g., up to 5 mm. The radial height may be selected for improved the sealing and to compensate diameter differences between adjoining parts, such as tube parts and connecting elements.

Similar annular protrusions 42, 43, 44 can be provided on the inside and outside contact surfaces of the connecting elements according to the invention, such as tube bends and branch pipes. Preferably, annular grooves are arranged on both sides of a protrusion, as shown for protrusions 26a and 44, for absorbing at least part of the deformation of the protrusion when it is compressed against a tube part.

FIG. 2c shows a part of a supporting means 32, to which a clamping arrangement is secured with bolt 29 and a domed nut 32′.

FIG. 2d is a cross section through high elasticity connecting element 21 that is also shown in FIG. 2a. The connecting element has essentially the shape of a solid of revolution around central axis X. The outer surface of element 21 comprises part 25 of larger outside diameter A essentially coinciding with the outside diameter of tube part 23, and adjacent part 33 of smaller outside diameter B essentially coinciding with the inside diameter of tube part 23.

Connecting element 21 is hollow and forms a flow-through channel 34 with a funnel shaped or conical part 36 that is tapered from the end 35 with the smaller outside diameter, and an adjacent part 37 with a cylindrical surface having a diameter F, which is suited to enclose the end of a smaller diameter tube part inserted therein.

The funnel shaped part 36 suitably exhibits at its end 35 a diameter which is somewhat smaller than the diameter A, for example with a difference of up to 20 mm, or up to 10 mm, and at the other, smaller, end 38 suitably has essentially the same or a somewhat smaller diameter than F, especially up to 10 mm smaller. At the transition between funnel shaped part 36 and cylindrical part 37, an inwardly extending shoulder or collar 39 is preferably provided, corresponding to the diameter difference between these parts, that is corresponding to a height G of, e.g., 1-5 mm. Shoulder 39 may act as a stop for the end of tube part 22 inserted into part 37.

At the other end 40 of connecting element 21, an outwardly protruding annular flange or bead 41 is preferably arranged with a longitudinal breadth E of, e.g., 1-10 mm and an outer diameter which preferably is 5-20 mm larger than dimension B. Bead 41 may act as a stop for sleeve 26 and compressing part 27.

On surfaces 25, 33 and 37, as well as on the corresponding contact surfaces of the tube bends and branch pipes, one or more annular protrusions consisting of ridges or beads 42, 43 and 44, respectively, may be arranged, which may be used for improving the seal against, and contact with, tube parts 22 and 23 and sleeve 26. The height of the protrusions is suitably at least 0,5 mm, up to 5 mm or 3 mm.

The longitudinal dimensions D and C of surfaces 25 and 33 depend on the diameter A and may suitably be between 20 and 50 mm, and they may suitably be equal to one another.

According to one embodiment of the invention, the longitudinal dimension of internal bore 40 from the end of connecting element 21 to shoulder 39 is larger than the distance E+D, so that the end of smaller diameter tube part 22 may extend a certain distance into past the end of larger diameter tube part 23. Thereby, the risk is reduced that in a fire that damages or destroys connecting element 21, the tube parts will fall apart or fall out of the suspending means.

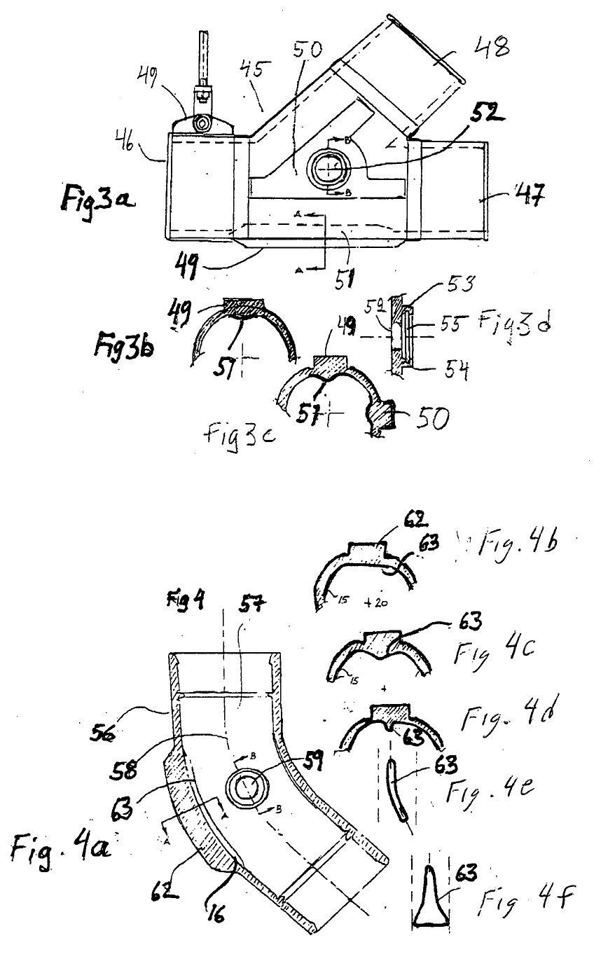

FIG. 3a shows a connecting element of high elasticity material consisting of a branch pipe 45 with three connection openings 46, 47 and 48, and with such inside diameters that the ends of tube parts can be inserted into these openings, preferably with a sealing fit. FIG. 3a shows compressing and supporting means 49, which may be arranged in the same way as those shown in FIGS. 2 and which compress connection opening 46 against a tube part end inserted therein. Similar compressing means may be arranged at the other openings 47 and 48. For the connection of tube parts having an outside diameter smaller than the inside diameter of a connection opening, a connecting element according to FIGS. 2 with a funnel-shaped expanding flow-through channel may as an alternative be arranged in one or more of the connection openings 46-48 for connecting and firmly holding one or more such tube parts with smaller outside diameter to the branch pipe. For strengthening, the branch pipe is also provided with a number of outside strengthening beads 49, 50 and one or more internal strengthening beads 51, which extend in the longitudinal direction of the branch pipe.

FIGS. 3b and 3c show partial sections A-A through the lower part of alternate versions of the branch pipe shown in FIG. 3a.

In a central part of the connecting element, or branch pipe, there is also arranged, in the wall of the branch pipe, a through opening 52, which extends from the outside of this element into the flow-through channel of the element, preferably essentially perpendicular to the longitudinal extent of the flow-through channel.

A partial section B-B through the wall at opening 52 is shown in FIG. 3d. The wall at the opening is suitably shaped or provided with means, such as a protruding part extending around the opening, for permitting closure of the opening with a closure element or the mounting of auxiliary means in or at the opening, such as a valve, pressure gauge, inspection window glass, etc. FIG. 3d shows one such means consisting of an annular protrusion 53 of the wall, which surrounds the opening 52 and is provided with an annular groove 54, and a means 55, which is disc-shaped or provided with a part that fits into the groove. Means 55 may be, e.g., a sealing closure, an inspection-window glass, a flow-through valve, etc., that can be inserted and held in protrusion 53.

A similar annular groove may be arranged in the outside wall of the protrusion, and a protruding part of a means functionally similar to means 55 can be fitted into that groove in order to be attached to the protrusion. Such means can be inserted or snapped-in for securing the means to the protrusion.

A similar opening, covered with a transparent window, may be arranged in the opposite side wall of the connecting element and be used, e.g., to provide an inlet for light from a lamp in order to permit viewing and inspecting, through opening 52, of the internal flow-through channel of the connecting element. Additional such openings may be arranged on either or both sides of the connecting element.

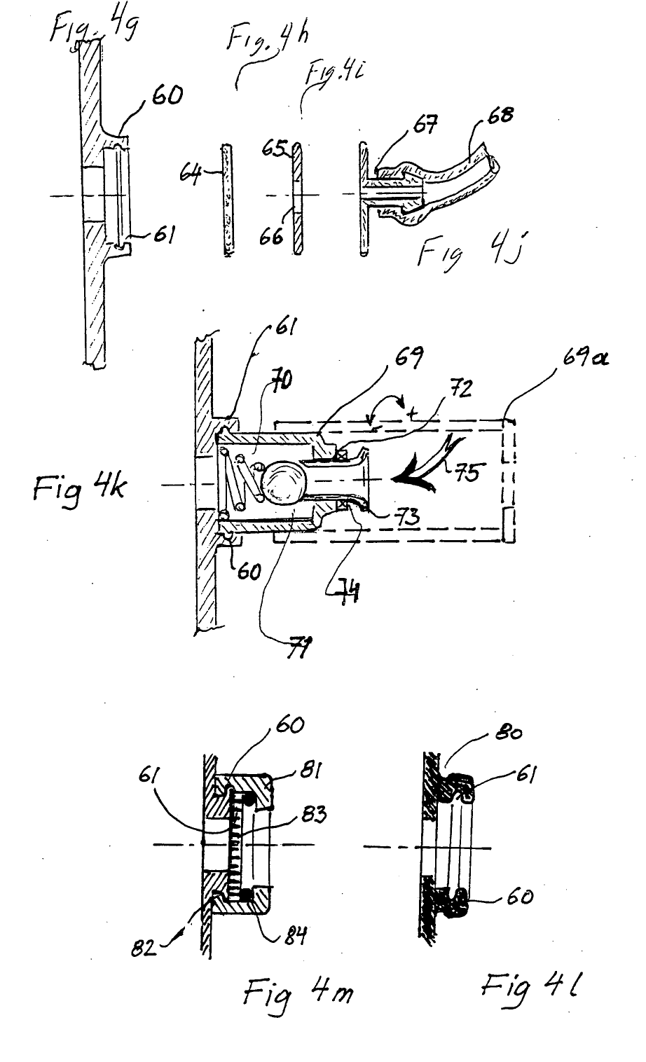

FIGS. 4a to 4f show a 450 tube bend 56 of high elasticity material and partial sections through the wall thereof. The interior of tube bend 56 forms a flow-through channel 57 with essentially circular cross section over a major part of the longitudinal extent of the channel with a central line or axis 58. In the side wall of the tube bend there is a through opening 59 similar to the opening 52 shown on FIGS. 3, which may be arranged in the same way and be used for the same purpose as opening 52.

FIG. 4a is a longitudinal cross sectional view through tube bend 56 and shows a reinforcing part 62, which is molded on the outer surface of bend 56 at the side thereof that is remote from the center of curvature of center line 58. On the inner surface of the tube bend, at the side thereof remote from the center of curvature of line 58, there is provided an inwardly protruding part 63, which causes the cross section to deviate from a circle, as is obvious from FIGS. 4b, c, d, which show sections through three variations of such protruding parts.

FIGS. 4e and f show two examples of the form of part 63, when viewed from center line 58 in a direction parallel to the plane of FIG. 4a. One or more such internal protrusions or wings may be arranged and may be used for improving the wear resistance and/or act as deflecting means for directing or deflecting the flow of gas and/or liquid and entrained solid material in a desired way, e.g., for counteracting wear or depositions at certain locations in or adjacent to the tube bend. Such internal protrusions or internal wall parts deviating from a circular cross section may also be used in other types of connecting elements according to the invention, e.g., 90° or other tube bends and branch pipes. The internal protrusions may extend along the entirety, or a major or minor part, of the longitudinal extent of the bend or the branch pipe, e.g., adjacent an inlet opening and/or an outlet opening. The protrusions may be made integral with the wall or may be attached thereto and consist of the same material as the wall or of a different material.

FIG. 4g shows a partial section through opening 59, including an adjacent part of the side wall of tube bend 56. A protrusion 60 is provided on the outer surface of the side wall surrounding opening 59. Protrusion 60 is provided with an internal annular groove 61. Components that may be mounted at opening 59 and held in protrusion 60 are shown in FIGS. 4h, i, j and k.

FIG. 4h shows a cross section through a slab, or plate, 64 of transparent or nontransparent material, which may be arranged in groove 61, preferably in a sealing manner. FIG. 4i shows a section through a disc 65 with a through opening 66 having a selected opening size, which permits a selected flow-through to a flow-through channel inside opening 59. FIG. 4j shows a section through a disc provided with an opening and with a pipe socket, or nipple, 67 for connecting a hose 68 to opening 59. Also, tube bends and other connecting elements may be provided with two opposite openings 59 that permit viewing of the flow-through channel through inspection window glasses arranged at such openings, as is shown in connection with FIGS. 3.

FIG. 4k shows a similar partial section with a valve means held in the groove 61. The valve means is provided for controlling flow through opening 59, and comprises a valve housing 69, which is held in groove 61. Inside valve housing 69 there is installed a spring 70 that urges a movable valve component consisting of a ball 71 sealingly against a valve seat comprising a valve seat opening 72 in a tubular sleeve 73. Sleeve 73 is screwed into a threaded opening 74 in valve housing 69. The opening pressure of the valve, i.e. the pressure difference between the ambient pressure and the flow-through channel pressure at the opening 59, at which the valve component 71 is lifted from seat opening 72 and permits flow through opening 59, as is indicated by the arrow 75, can be adjusted by screwing in the sleeve to an adjustable depth while compression of spring 70. The valve may also be provided with oscillation dampening means, which counteracts tendencies for valve components and spring means experience undesired uncontrolled oscillations with alternating short-time openings and closures of the valve, which would disturb the flow and causes wear and noise. The oscillation dampening means may comprise materials, e.g., rubber, in the valve seat and valve cone (valve component), which dampen oscillations and rebounding, or, e.g., a valve cone or valve ball that is magnetic and cooperates with magnetic means.

The openings 52, 59 in the connecting elements and optionally cooperating valve means may be used for permitting the inlet of air at one or more locations of the system when needed, e.g., at the start of a sub-atmospheric pressure generator, or when there is clogging or risk for clogging of the tubing system, etc. and thereby increase the flow speed and/or pressure drop at desired locations. The valve means may be adjustable and/or controllable by mechanical, hydraulic, pneumatic, electric and/or magnetic means, or by a combination of two or more of these, and may be arranged to be actuated automatically or manually, at each separate valve or at a group of valves or centrally for a number of valves. The operation of a valve may hereby be governed or influenced by existing conditions, such as the pressure and/or flow speed and/or the density/loading ratio of the flowing medium at one or more upstream and/or downstream positions of the system in the flow direction, such as the pressure differences between various measuring points caused by clogging between these points. The valve means may, e.g., be hald against the valve seat entirely or partly by magnetic forces created by a permanent magnet and/or an electro magnet, which in a first opening phase decrease rapidly with increasing opening distance between the valve component and the valve seat.

FIG. 4k shows an example of a sound dampening means 69a for the inlet opening of the valve.

FIGS. 4l and 4m show partial sections through protrusions 60 similar to FIGS. 4g and 4k, but with an external groove 80 for holding means to the protrusion. Each protrusion 60 is provided with a secondary opening to the flow-through channel. External groove 80 permits the holding of a detachable part 81, which is provided with a protrusion 82 fitting into groove 80. FIG. 4m shows such a part 81 resembling a cap, which holds an inspection window glass 83 with an intermediate sealing and/or resilient means consisting of an elastic O-ring 84.

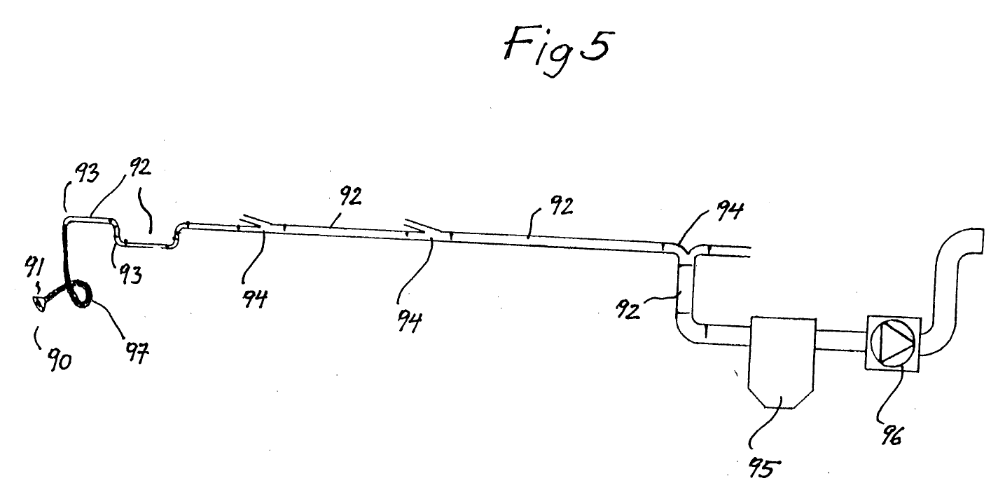

FIG. 5 shows in simplified form an example of a use of the invention wherein it is desired to remove dust and smoke by suction from a working station, in this case a welding station 90. For this purpose a so-called point exhaustion system is used, comprising a tubing system according to the invention constructed with tube parts and connecting elements such as disclosed in connection with FIGS. 1 to 4 and which is suited for removal and transport of particle materials to a collecting means, in this case capture of particles and smoke from the welding position 90 with a suction hood 91 and transport through a tube conduit comprising tube parts 92 of low elasticity material consisting of steel tubes with external or internal diameter between about 50 and 200 mm, e.g., about 51 mm, 76 mm or 108 mm, connected by tube bends 93 and branch pipes 94 of high elasticity material, e.g., rubber, to a separation device 95 comprising a cyclone as a pre-separator and a filter as dust separator, using a low-pressure source (vacuum source) 96 comprising a turbo pump or radial fan.

For achieving this it is necessary to create a high air speed in the capture zone 90, 91, so that the air can bring with it the particles. The air is put in motion by a pressure difference, i.e. by creating a low pressure in the inlet of the exhaust hood 91.

The impurities (air-gas and particles) then must be transported in suction hoses 97 and in the tubing system 92, 93, 94. This requires a high air speed (about 20 meters/second) for preventing the particles from falling down and forming depositions in the tubing system.

The high speed of the air causes friction and impact losses in the channel. The flow in a tube is turbulent and can form eddies. The resistance (pressure drop) is caused not only by viscosity forces but particularly by forces of inertia, since the eddies slow down the flow.

The pressure drop in a tube is proportional to the square of the fluid flow speed. The pressure drop also depends on the ruggedness of the tube system and on the density of the air mixture. At tube bends, tube branchings and tube transitions, separate losses are caused. By shaping tube bends, branch pipes and transitions in a suitable way these losses may be restricted. The internal shape of the flow channel in the tube system should be as smooth as possible.

In order to overcome these flow resistances, it is necessary to reduce the pressure levels along the entire tubing. The flow causes a continuous pressure drop. At the end of the system, dust and particles are separated in dynamic separators, such as a cyclone, and filters. This also causes a flow resistance and a pressure drop. For carrying through this entire sequence, a vacuum source (pump or fan) is required, which creates a negative pressure large enough to maintain the flow. The negative pressure is in these connections often called a vacuum. The vacuum level may suitably be adjusted with a vacuum valve adjacent the pump for preventing overheating of the pump motor.

The action of the point exhaust system is thus influenced by the system construction and the actual load on the system. Thus, what is made possible is a system which always gives precisely the planned air flows at the point of exhaust. In reality the air flow is, however, influenced by a number of factors, such as, e.g., the opening area at the point of exhaust and the density of the dust particles and various pressure losses in the channel.

Low air speed values and an unduly high dust density often cause complicated stoppages in the tubing. Unduly high air speeds with a large dust quantity cause wear of especially tube bends and branch pipes. Thus, a balanced speed in hoses and tubes is desired. Another desired effect is to reduce vibrations and the noise. When the tubing system is fastened to a building, the noise caused by the turbulent flow (the particles bounce against the tube walls) when using conventional tubing systems may be transferred to the framework of the building. The noise can be very disturbing, especially in sensitive industry environments. At the same time it is also desired that the tube parts be suspended in a way that is secure in case of a fire.

In modern industry, the point exhaust system is an important factor in the production process. Thus, it is desired to provide system components that can be rapidly disassembled, exchanged and adapted to new conditions, which is achieved according to the invention.

At high dust loads, control of a vacuum valve arranged adjacent to the pump presents problems. Especially at high dust loads in the tubing system, such a vacuum valve has a tendency to open so that the flow speed in the tubing system is reduced to unacceptably low speed values. This problem, also, is solved according to the invention with the aid of valves for inlet of additional air (secondary air) arranged in secondary openings in connecting elements according to the invention.

The present invention relates to subject matter disclosed in Swedish Patent Application No. 0502897-2, filed on Dec. 23, 2005, the disclosure of which is incorporated herein by reference

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A tubing system comprising:
a plurality of tube parts; and
connecting elements for connecting said tube parts together to form a fluid flow-through channel for transporting a substance in an entraining fluid, wherein:
said tube parts are made of a low elasticity material and said connecting elements are made of a high elasticity material having a Young's Modulus lower than said low elasticity material;
at least one of said connecting elements has a side wall provided with an opening to permit entry of supplemental entraining fluid to speed the flow of the substance along the channel; and,
at least two of said tube parts are joined together by one of said connecting elements to form a part of the channel.

2. The tubing system of claim 1, wherein at least one of said connecting elements is shaped for changing at least one of the speed and direction of flow through said at least one of said connecting elements.

3. The tubing system of claim 1, wherein at least one of said connecting elements comprises elastically supported carrying means for tube parts connected to and carried by said at least one of said connecting elements.

4. The tubing system of claim 1, wherein said high elasticity material is an elastomer material.

5. The tubing system of claim 4, wherein said elastomer material is at least one of: natural rubber; synthetic rubber; and polyurethane.

6. The tubing system of claim 1, wherein said high elasticity material has a Young's Modulus equal to or less than 100 Mpa.

7. The tubing system of claim 1, wherein said low elasticity material is at least one of a metal and a plastic.

8. The tubing system of claim 1, wherein said low elasticity material is at least one of iron, copper, aluminum and alloys thereof.

9. The tubing system of claim 1, wherein said low elasticity material is a rigid plastic.

10. The tubing system of claim 9, wherein said rigid plastic is at least one of PVC, polyester, polyethylene and polypropylene.

11. The tubing system of claim 1, wherein said low elasticity material has a Young's Modulus equal to or greater than 500 Mpa.

12. The tubing system of claim 1, wherein at least one said connecting elements comprises at least one of a curved flow-through channel, and a flow-through channel with at least three connections for tube parts.

13. The tubing system of claim 1, wherein said tubing system is housed in a building and further comprises means for supporting at least one of said connecting element elastically supported by the building.

14. The tubing system of claim 1, further comprising means for applying a pressure below or above atmospheric for conveying the entraining fluid along said fluid flow-through channel.

15. A connecting element made of elastomer material and providing a part of flow-through channel, said connecting element being adapted for connecting at least two tubes parts having the same or different inside diameters and forming further parts of the flow-through channel, said connecting element and the connected tube parts being adapted to form part of a tubing system for transporting a substance in an entraining fluid through the channel, wherein said connecting element is formed such that the part of the flow-through channel provided by said connecting element has an internal shape that can cause a change of at least one of the direction of flow and the speed of a medium flowing through the flow-through channel.

16. The connecting element of claim 15, wherein at least a portion of the part of the flow-through channel provided by said connecting element has a noncircular cross section.

17. A method of transporting a heterogeneous fluid substance in an homogeneous entraining fluid through the flow-through channel of the system defined in claim 1, comprising:
disposing an inlet end of the tubing system at a location from which the heterogeneous fluid substance is to be transported and at which and which contains the homogeneous entraining fluid; and
creating a pressure differential between the inlet end and an outlet end of the tubing system sufficient to transport the fluid substance and the entraining fluid from the inlet end to the outlet end of the tubing system.

18. The method of claim 17, further comprising introducing additional entraining fluid into the flow-through channel through the opening in the side wall of the at least one of the connecting elements.
